(19) United States
(12) Patent Application Publication
(10) Pub. No.: US 2011/0205260 A1
(43) Pub. Date: Aug. 25, 2011

(54) LIQUID CRYSTAL DISPLAY DEVICE AND DRIVING METHOD THEREOF

(76) Inventors: Ming-Chi Weng, Kinmen County (TW); Hung-Hsiang Chen, Taoyuan County (TW); Yi-Nan Chu, Changhua County (TW)

(21) Appl. No.: 12/777,270

(22) Filed: May 11, 2010

(30) Foreign Application Priority Data
Feb. 24, 2010 (TW) 099105292

(51) Int. Cl. G09G 3/36; G09G 5/00; G09G 5/10

(52) U.S. Cl. 345/691; 345/211; 345/213; 345/89

(57) ABSTRACT

A liquid crystal display device includes a plurality of gate lines, a plurality of main data lines, a plurality of sub-data lines, a switch circuit and a pixel array. The gate lines are configured to transmit a plurality of gate driving signals, while the data lines and sub-data lines are configured to transmit a plurality of data driving signals. The switch circuit controls the paths through which the data driving signals are transmitted to the sub-data lines. The pixel array includes a plurality of first and second pixel units. Each first pixel unit displays images according to the gate driving signal received from a corresponding gate line and the data driving signal received from a corresponding main data line. Each second pixel unit displays images according to the gate driving signal received from a corresponding gate line and the data driving signal received from a corresponding sub-data line.

### BACKGROUND OF THE INVENTION

1. Field of the Invention

The present invention is related to a liquid crystal display device and driving method thereof, and more particularly, to a liquid crystal display device having a pixel level multiplexing structure and driving method thereof.

2. Description of the Prior Art

Liquid crystal display (LCD) devices, characterized in low radiation, thin appearance and low power consumption, have gradually replaced traditional cathode ray tube (CRT) displays and been widely used in electronic products, such as notebook computers, personal digital assistants (PDAs), flat-panel TVs or mobile phones.

FIG. 1 is a diagram illustrating a prior art LCD device 100. The LCD device includes an LCD panel 110, a source driver 120, a gate driver 130, and a timing controller 140. 2M data lines DL₁-DL_{2M}, N gate lines GL₁-GL_{N}, and a pixel array are disposed on the LCD panel 110. The pixel array includes (2M)*N pixel units in which the first to the Nth rows of pixel units are denoted by PX₁-PX_{N}, respectively. Each pixel unit, including a thin film transistor switch TFT, a liquid crystal capacitor C_{LC} and a storage capacitor C_{ST}, is coupled to a corresponding data line, a corresponding gate line and a common voltage V_{COM}. The timing controller 140 is configured to generate control signals for operating the source driver 120 and the gate driver 130, such as a start pulse signal VST, a horizontal synchronization signal HSYNC, and a vertical synchronization signal VSYNC. According to the start pulse signal VST and the vertical synchronization signal VSYNC, the gate driver 130 respectively outputs gate driving signals SG₁-SG_{N} to the gate lines GL₁-GL_{N}, thereby turning on the thin film transistor switches TFT in the corresponding rows of pixel units. According to the horizontal synchronization signal HSYNC, the source driver 120 respectively outputs data driving signals SD₁-SD_{2M} to the data lines DL₁-DL_{2M}, thereby charging the liquid crystal capacitors C_{LC} and the storage capacitors C_{ST} in the corresponding columns of pixel units.

FIG. 2 is a diagram illustrating a prior method for driving the LCD device 100. FIG. 2 shows the waveforms of a system clock signal VCK and the gate driving signals SG₁-SG_{N}. During the enable periods T₁-T_{N} (such as when the gate driving signals SG₁-SG_{N} are at high level), the data driving signals are written into corresponding pixel units. When driving the prior art LCD device 100, the gate driving signals SG₁-SG_{N} are sequentially outputted to the corresponding gate lines GL₁-GL_{N}: when the gate line GL₁ is enabled, the data driving signals SD₁-SD_{2M} related to the display images of the first row of pixel units PX₁ are sequentially outputted via the corresponding data lines DL₁-DL_{2M}; when the gate line GL₂ is enabled, the data driving signals SD₁-SD_{2M} related to the display images of the second row of pixel units PX₂ are sequentially outputted via the corresponding data lines DL₁-DL_{2M}; . . . ; when the gate line GL_{N} is enabled, the data driving signals SD₁-SD_{2M} related to the display images of the Nth row of pixel units PX_{N} are sequentially outputted via the corresponding data lines DL₁-DL_{2M}. In the prior LCD device 100, each pixel unit receives data driving signals from the data line disposed on the left side, thereby providing (2M)*N resolution. While the resolution may be increased by implementing more data lines, the source driver 120 needs to be able to provide more output channels accordingly. In large-size or high-resolution applications, the LCD device 100 normally adopts a plurality of source drivers, which further increases manufacturing costs. On the other hand, the enable periods T₁-T_{N} of the gate driving signals S_{G1} S_{GN} may largely be shortened when the system clock signal VCK is raised in high-frequency applications. As a result, the pixel units may not be able to reach predetermined levels due to insufficient charge time, thereby influencing the display quality.

FIG. 3 is a diagram illustrating another prior art LCD device 200. The LCD device 200 includes an LCD panel 210, a source driver 220, a gate driver 230, and a timing controller 240. M data lines DL₁-DL_{M}, N gate lines GL₁-GL_{N}, and a pixel array are disposed on the LCD panel 210. The pixel array includes (2M)*N pixel units in which the (M*N) pixel units disposed on the left side of the data lines are denoted by PX_{A} and the (M*N) pixel units disposed on the right side of the data lines are denoted by PX_{B}. Each pixel unit PX_{A}, including a thin film transistor switch TFT1, a liquid crystal capacitor C_{LC} and a storage capacitor C_{ST}, is coupled to a corresponding data line, a corresponding gate line and a common voltage V_{COM}. Each pixel unit PX_{B}, including two thin film transistor switches TFT2 and TFT3, a liquid crystal capacitor C_{LC} and a storage capacitor C_{ST}, is coupled to a corresponding data line, two corresponding gate lines and a common voltage V_{COM}. The timing controller 240 is configured to generate control signals for operating the source driver 220 and the gate driver 230, such as a start pulse signal VST, a horizontal synchronization signal HSYNC, and a vertical synchronization signal VSYNC. According to the start pulse signal VST and the vertical synchronization signal VSYNC, the gate driver 230 respectively outputs gate driving signals SG₁-SGₙ to the gate lines GL₁-GL_{N}, thereby turning on the thin film transistor switches in corresponding pixel units. According to the horizontal synchronization signal HSYNC, the source driver 220 respectively outputs data driving signals SD₁-SD_{M} to the data lines DL₁-DL_{M}, thereby charging the liquid crystal capacitors C_{LC} and the storage capacitors C_{ST} in corresponding columns of pixel units.

FIG. 4 is a diagram illustrating a prior method for driving the LCD device 200. FIG. 4 shows the waveforms of the system clock signal VCK and the gate driving signals SG₁-SG_{N}. During the enable periods (such as when the gate driving signals SG₁-SG_{N} are at high level), the data driving signals are written into corresponding pixel units. For the nth row of pixel units coupled to the gate line GLₙ, data is written into the pixel units PX_{B} when both the gate lines GLₙ and GLₙ₊₁ are enabled, and into the pixel units PX_{A} when only the gate line GLₙ is enabled. As shown in FIG. 4, the process of writing data when driving the LCD device 200 includes five periods Tₙ₁-Tₙ₅, wherein Tₙ₄ is the main charge period of the pixel units PX_{B}, Tₙ₅ is the main charge period of the pixel units PX_{A}, Tₙ₁ is the precharge period of the pixel units PX_{B}, and Tₙ₁, Tₙ₂, Tₙ₄ are the precharge periods of the pixel units PX_{A}.

The LCD device 200 adopts a pixel level multiplexing (PLM) structure in which two columns of pixel units share the same data line. The pixel units PX_{A} receive data signals from the data lines disposed on the right side, while the pixel units PX_{B} receive data signals from the data lines disposed on the left side. Therefore, the LCD device 200 can provide (2M)*N resolution using M data lines and N gate lines. However, a more complicated process is required to the manufacture two thin film transistor switches TFT2 and TFT3 in each pixel unit PX_{B} so that the correct data can be written into the corresponding pixel units PX_{A} or PX_{B}. Since the aperture ratio of liquid crystal decreases as the number of the film transistor switches increases, stronger backlight is required for maintaining the same luminance, which also increases power consumption. Meanwhile, the prior art method for driving the LCD device 200 is very complicated in which a complete cycle of writing data is equal to the length of five cycles in the system clock signal VCK. With longer driving time of a frame, the display quality may be influenced due to insufficient scan frequency.

### SUMMARY OF THE INVENTION

The present invention provides a liquid crystal display device including a plurality of gate lines configured to transmit a plurality of gate driving signals, a plurality of main data lines disposed perpendicular to the plurality of gate lines and configured to transmit a plurality of data driving signals, a plurality of sub-data lines disposed perpendicular to the plurality of gate lines and configured to transmit the plurality of data driving signals, a pixel array and a switch circuit configured to control paths through which the plurality of data driving signals are transmitted to the plurality of sub-data lines. The pixel array includes a plurality of first pixel units respectively disposed at locations where the plurality of gate lines and the plurality of main data lines intersect, wherein each first pixel unit is configured to display images according to a gate driving signal received from a corresponding gate line and a data driving signal received from a corresponding main data line; and a plurality of second pixel units respectively disposed at locations where the plurality of gate lines and the plurality of sub-data lines intersect, wherein each second pixel unit is configured to display images according to a gate driving signal received from a corresponding gate line and a data driving signal received from a corresponding sub-data line.

The present invention also provides a driving method of a liquid crystal display device which includes a gate line, a main data line disposed perpendicular to the gate line, a sub-data line disposed perpendicular to the gate line, a first pixel unit disposed at a location wherein the gate line and the main data line intersect, and a second pixel unit disposed at a location wherein the gate line and the sub-data line intersect. The driving method includes providing a first data driving signal of a first polarity according to an image grayscale value of the first pixel unit, providing a second data driving signal of a second polarity according to an image grayscale value of the second pixel unit, simultaneously turning on the first pixel unit and the second pixel unit during a first enable period, turning on the first pixel unit during a second enable period subsequent to the first enable period, charging the second pixel unit and precharging the first pixel unit by outputting the second data driving signal to the main data line and the sub-data line during the first enable period, charging the first pixel unit by outputting the first data driving signal to the main data line during the second enable period, and adjusting a length of the first enable period and a length of the second enable period based on the first polarity and the second polarity.

The present invention also provides a driving method of driving a liquid crystal display device which includes a first gate line, a second gate line, a third gate line, a main data line and a sub-data line disposed perpendicular to the first gate line, the second gate line and the third gate line, a first pixel unit disposed at a location wherein the first gate line and the main data line intersect, a second pixel unit disposed at a location wherein the first gate line and the sub-data line intersect, a third pixel unit disposed at a location wherein the second gate line and the main data line intersect, a fourth pixel unit disposed at a location wherein the second gate line and the sub-data line intersect, a fifth pixel unit disposed at a location wherein the third gate line and the main data line intersect, and a sixth pixel unit disposed at a location wherein the third gate line and the sub-data line intersect. The driving method includes providing a first data driving signal according to an image grayscale value of the first pixel unit, a second data driving signal according to an image grayscale value of the second pixel unit, a third data driving signal according to an image grayscale value of the third pixel unit, a fourth data driving signal according to an image grayscale value of the fourth pixel unit, a fifth data driving signal according to an image grayscale value of the fifth pixel unit, and a sixth data driving signal according to an image grayscale value of the sixth pixel unit; simultaneously turning on the first pixel unit, the second pixel unit, the fifth pixel unit and the sixth pixel unit during a first enable period; simultaneously turning on the first pixel unit and the second pixel unit during a second enable period subsequent to the first enable period; charging the second pixel unit and precharging the first pixel unit, the fifth pixel unit and the sixth pixel unit by outputting the second data driving signal to the main data line and the sub-data line during the first enable period; and charging the first pixel unit by outputting the first data driving signal to the main data line during the second enable period.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a prior art LCD device.

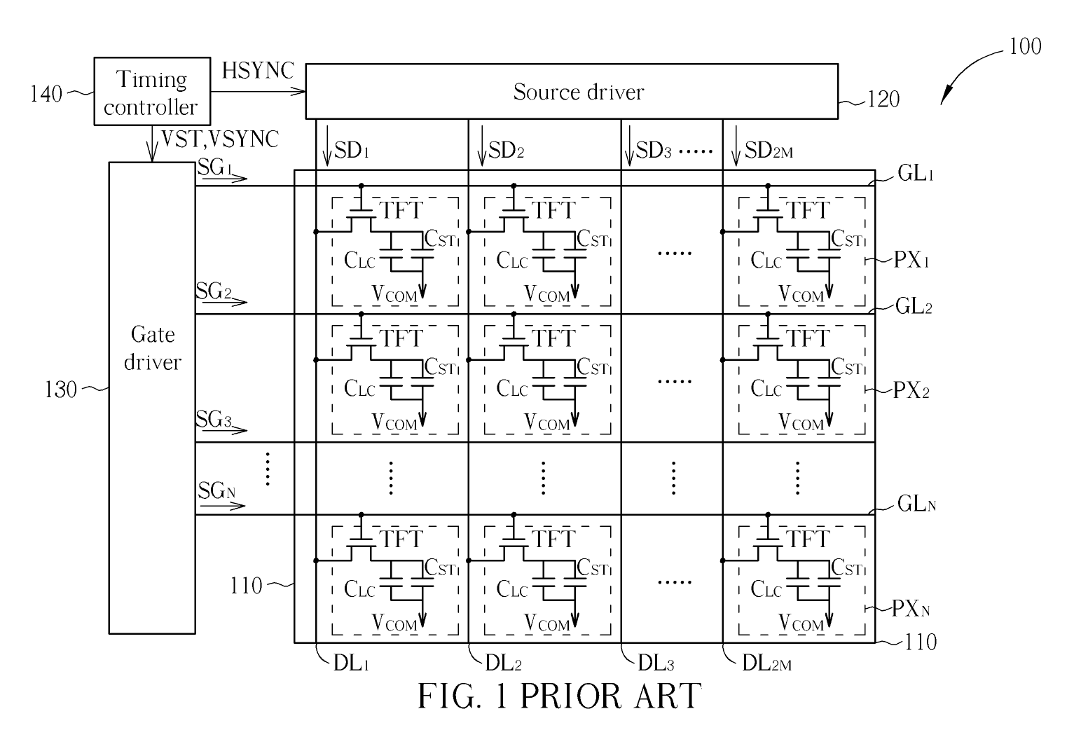

FIG. 2 is a diagram illustrating a prior method for driving the LCD device in FIG. 1.

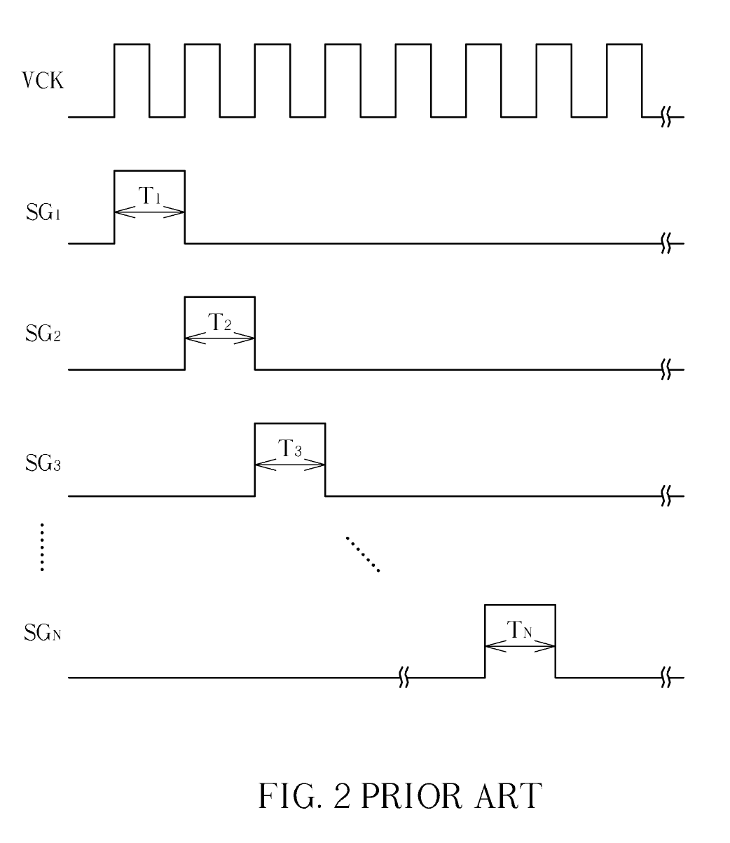

FIG. 3 is a diagram illustrating another prior art LCD device.

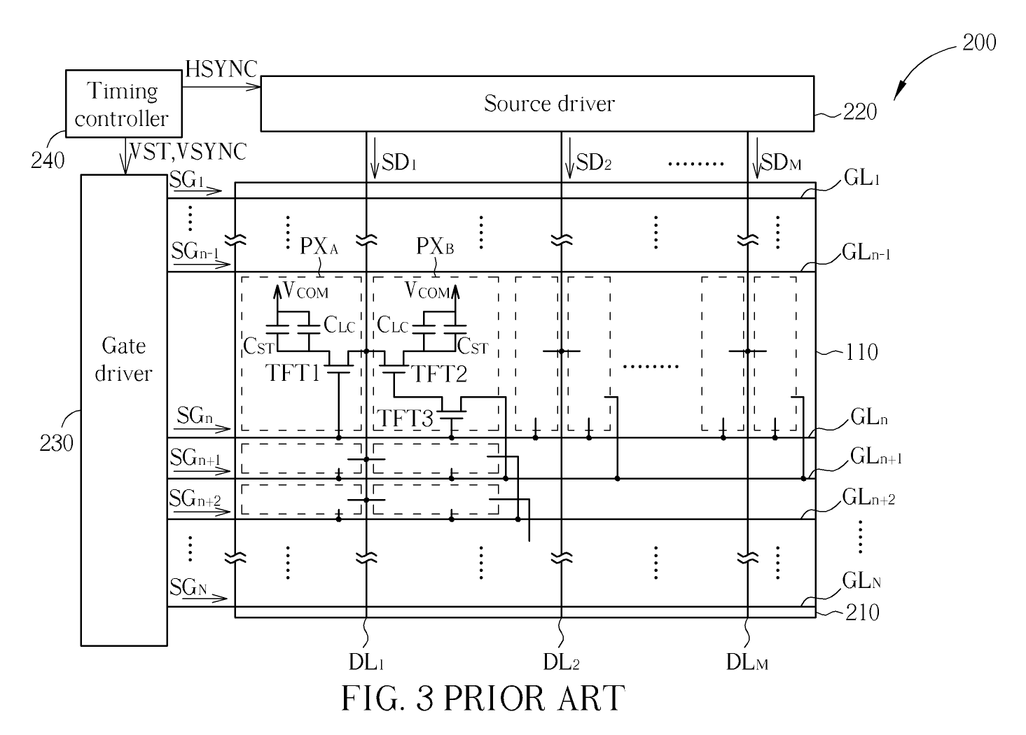

FIG. 4 is a diagram illustrating a prior method for driving the LCD device in FIG. 3.

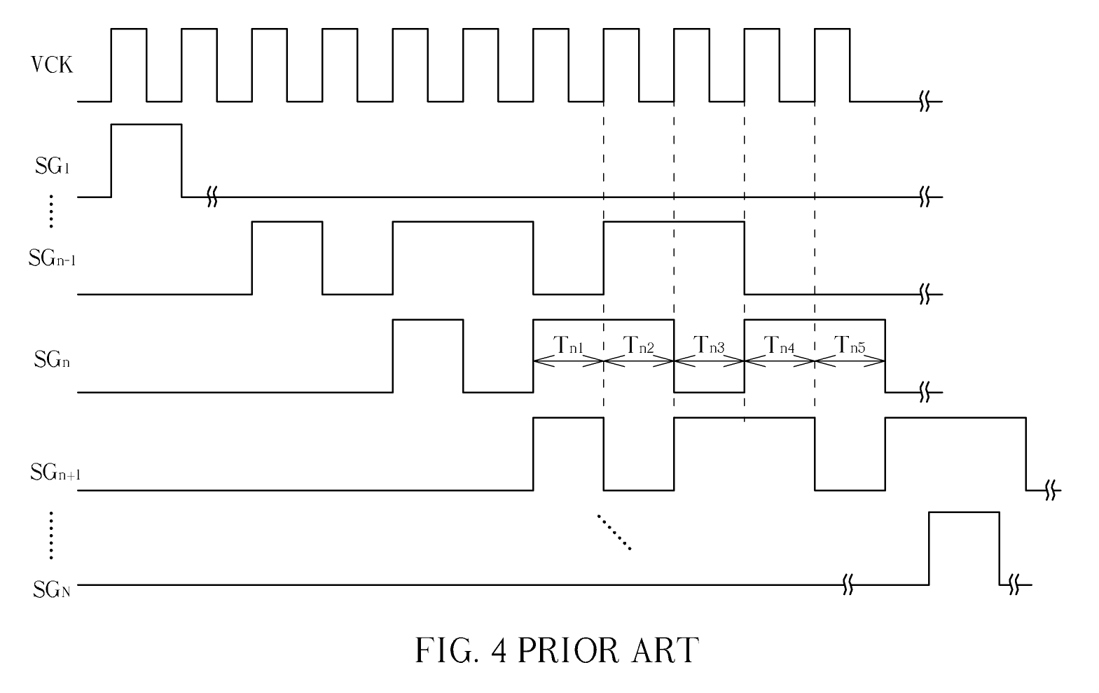

FIG. 5 is a diagram illustrating an LCD device according to the present invention.

FIG. 6 is a diagram illustrating a driving method of an LCD device according to a first embodiment of the present invention.

FIG. 7 is a diagram illustrating a driving method of an LCD device according to a second embodiment of the present invention.

### DETAILED DESCRIPTION

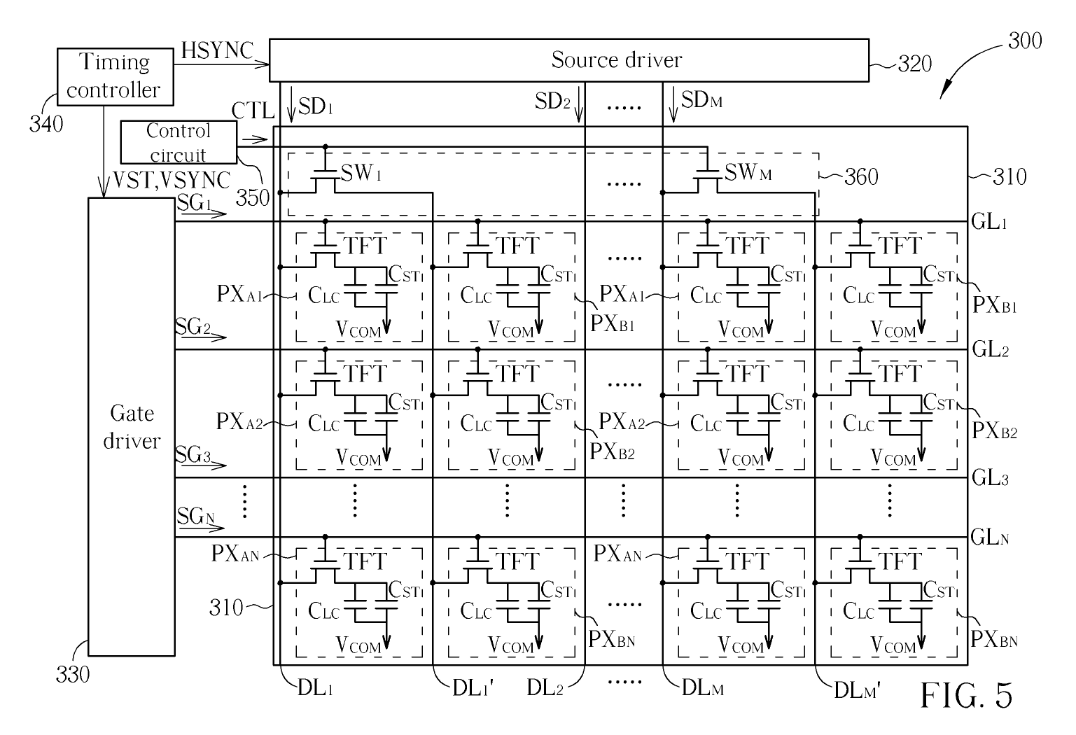

FIG. 5 is a diagram illustrating an LCD device 300 having PLM structure according to the present invention. The LCD device 300 includes an LCD panel 310, a source driver 320, a gate driver 330, a timing controller 340, and a control circuit 350. M main data lines DL1-DLM, M sub-data lines DL1′-DLM′, N gate lines GL1-GLN, a switch circuit 360, and a pixel array are disposed on the LCD panel 310. The pixel array includes (2M)*N pixel units in which the (M*N) pixel units coupled to the main data lines DL1-DLM are denoted by PXA1-PXAN and the (M*N) pixel units coupled to the sub-date lines DL1′-DLM′ are denoted by PXB1-PXBN. Each pixel unit, including a thin film transistor switch TFT, a liquid crystal capacitor CLC and a storage capacitor CST, is coupled to a corresponding main data or a corresponding sub-data line, a corresponding gate line and a common voltage VCOM. The timing controller 340 is configured to generate control signals for operating the source driver 320, the gate driver 330 and the control circuit 350, such as a start pulse signal VST, a horizontal synchronization signal HSYNC, and a vertical synchronization signal VSYNC. According to the start pulse signal VST and the vertical synchronization signal VSYNC, the gate driver 330 respectively outputs gate driving signals SG1-SGN to the gate lines GL1-GLN, thereby turning on the thin film transistor switches in the corresponding rows of pixel units. According to the horizontal synchronization signal HSYNC, the source driver 320 respectively outputs data driving signals SD1-SDM, which are related to the grayscale values of display images, to the main data lines DL1-DLM, thereby charging the liquid crystal capacitors CLC and the storage capacitors CST in corresponding columns of pixel units. Meanwhile, the switch circuit 360 includes M switches SW1-SWM and is configured to control the signal transmission paths through which the data driving signals SD1-SDM are transmitted to the sub-data lines DL1′-DLM′. In the embodiments of the present invention, the switches SW1-SWM may be, but not limited to, thin film transistor switches or other devices having similar function.

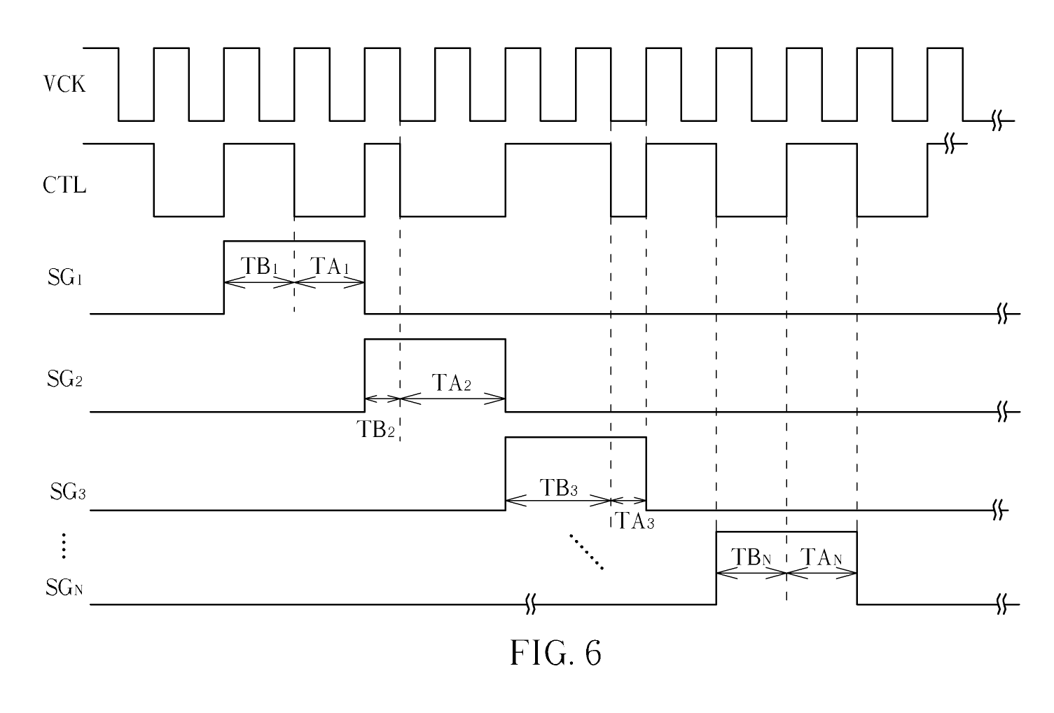

FIG. 6 is a diagram illustrating a method for driving the LCD device 300 according to a first embodiment of the present invention. FIG. 6 shows the waveforms of a system clock signal VCK, a control signal CTL, and the gate driving signals SG1-SGN. During the enable periods (TB1+TA1)−(TBN+TAN) (such as when the gate driving signals SG1-SGN are at high level), the data driving signals are written into corresponding pixel units. For the first row of pixel units PXA1 and PXB1, the control signal CTL and the gate driving signal SG1 turn on the switches SW1-SWM during the period TB1, so as to write the data driving signals SD1-SDM into corresponding pixel units PXA1 respectively via the main data lines DL1-DLM and simultaneously into corresponding pixel units PXB1 respectively via the sub-data lines DL1′-DLM′. Since the data driving signals SD1-SDM outputted from the source driver 320 during this period are related to the image grayscale values of the pixel units PXB1, TB1 is the main charge period of the first row of pixel units PXB1 and the precharge period of the first row of pixel units PXA1. Next, as the control signal switches to disable level (such as low level) during the period TA1 and thereby turn off the switches SW1-SWM, the data driving signals SD1-SDM are only written into corresponding pixel units PXA1 respectively via the main data lines DL1-DLM. Since the data driving signals SD1-SDM outputted from the source driver 320 during this period are related to the image grayscale values of the pixel units PXA1, TA1 is the main charge period of the first row of pixel units PXA during which data previously written during the precharge period TB1 is over-written. Similarly, for the second row of pixel units PXA2 and PXB2, TB2 is the main charge period of the pixel units PXB2 and the precharge period of the pixel units PXA2, while TA2 is the main charge period of the pixel units PXA2; . . . ; for the Nth row of pixel units PXAN and PXBN, TBN is the main charge period of the pixel units PXBN and the precharge period of the pixel units PXAN, while TAN is the main charge period of the pixel units PXAN.

When driving the LCD device 300 using dot inversion, the pixel units coupled to the main data lines DL1-DLM and the sub-data lines DL1′-DLM′ need to be driven with opposite polarities. Since positive data simultaneously precharges the pixel units PXA1-PXAN when written into the pixel units PXB1-PXBN, the pixel units PXA1-PXAN may have insufficient charge time when negative data is written during the corresponding main charge period. On the other hand, if the pixel units coupled to the main data lines DL1-DLM and the sub-data lines DL1′-DLM′ are driven with the same polarity, the pixel units PXA1-PXAN are already precharged by data of the same polarity when written into the pixel units PXB1-PXBN. The pixel units PXA1-PXAN may thus require a shorter main charge period. In the driving period according to the first embodiment as illustrated in FIG. 6, the control signal CTL is configured to adjust how long data is written into the pixel units PXA1-PXAN and the pixel units PXB1-PXBN by varying its duty cycle. For example, when the duty cycle of the control signal CTL is set to 50%, the main charge period and precharge period of the pixel units PXA1 have the same length (such as TA1=TB1); when the duty cycle of the control signal CTL is set to 25%, the main charge period of the pixel units PXA2 is shorter than the precharge period of the pixel units PXA2 (such as TA2<TB2); when the duty cycle of the control signal CTL is set to 75%, the main charge period of the pixel units PXA3 is longer than the precharge period of the pixel units PXA3 (such as TA3>TB3).

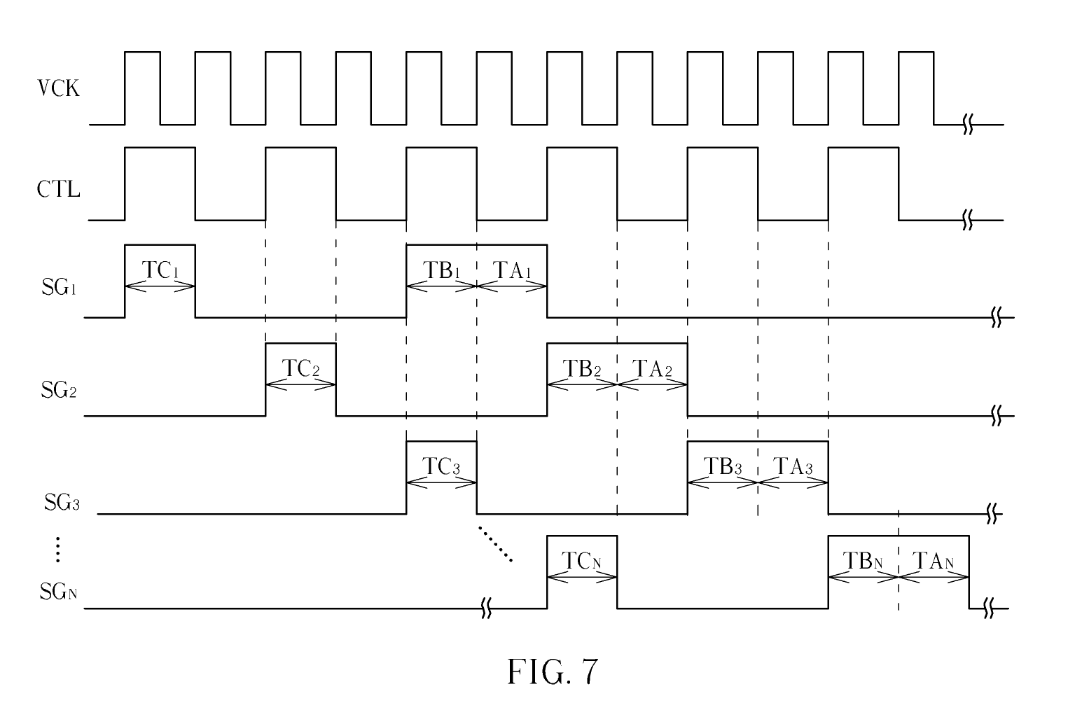

FIG. 7 is a diagram illustrating a method for driving the LCD device 300 according to a second embodiment of the present invention. FIG. 7 shows the waveforms of the system clock signal VCK, the control signal CTL, and the gate driving signals SG1-SGN. During the enable periods (TA1+TB1+TC1)−(TAN+TBN+TCN) (such as when the gate driving signals SG1-SGN are at high level), the data driving signals are written into corresponding pixel units. For the first row of pixel units PXA1/PXB1 and the third row of pixel units PXA3/PXB3, the control signal CTL, the gate driving signal SG1 and the gate driving signal SG3 turn on the switches SW1-SWM during the period TB1, so as to write the data driving signals SD1-SDM into corresponding pixel units PXA1 and PXA3 respectively via the main data lines DL1-DLM and simultaneously into corresponding pixel units PXB1 and PXB3 respectively via the sub-data lines DL1′-DLM′. Since the data driving signals SD1-SDM outputted from the source driver 320 during this period are related to the image grayscale values of the pixel units PXB1, TB1 is the main charge period of the first row of pixel units PXB1 and the precharge period of the first row of pixel units PXA1, PXA3 and PXB3. Next, as the control signal and the gate driving signal SG3 switch to disable level (such as low level) during the period TA1 and thereby turn off the switches SW1-SWM, the data driving signals SD1-SDM are only written into corresponding pixel units PXA1 respectively via the main data lines DL1-DLM. Since the data driving signals SD1-SDM outputted from the source driver 320 during this period are related to the image grayscale values of the pixel units PXA1, TA1 is the main charge period of the first row of pixel units PXA during which data previously written during the precharge period TB1 is over-written. Similarly, for the second row of pixel units PXA2 and PXB2 and the fourth row of pixel units PXA4 and PXB4, TB2 is the main charge period of the pixel units PXB2 and the precharge period of the pixel units PXA2, PXA4 and PXB4, while TA2 is the main charge period of the pixel units PXA2; for the third row of pixel units PXA3 and PXB3 and the fifth row of pixel units PXA5 and PXB5, TB3 is the main charge period of the pixel units PXB3 and the precharge period of the pixel units PXA3, PXA5 and PXB5, while TA3 is the main charge period of the pixel units PXA3; the same continues for the entire frame of image.

The LCD device 300 of the present invention adopts PLM structure which provides (2M)*N resolution using M main data lines, M sub-data lines and N gate lines. Since the switch circuit 360 is configured to control the signal transmission paths through which the data driving signals are transmitted to the main data lines and the sub-data lines, the source driver 320 only needs to provide M channels and each pixel unit only requires one thin film transistor switch. The PLM LCD device of the present invention may be driven by an uncomplicated method which can improve display quality by adjusting the main charge period and the precharge period based on data polarity.

Those skilled in the art will readily observe that numerous modifications and alterations of the device and method may be made while retaining the teachings of the invention.

What is claimed is:

1. A liquid crystal display device comprising:
a plurality of gate lines configured to transmit a plurality of gate driving signals;
a plurality of main data lines disposed perpendicular to the plurality of gate lines and configured to transmit a plurality of data driving signals;
a plurality of sub-data lines disposed perpendicular to the plurality of gate lines and configured to transmit the plurality of data driving signals;
a pixel array comprising:
a plurality of first pixel units respectively disposed at locations where the plurality of gate lines and the plurality of main data lines intersect, wherein each first pixel unit is configured to display images according to a gate driving signal received from a corresponding gate line and a data driving signal received from a corresponding main data line; and
a plurality of second pixel units respectively disposed at locations where the plurality of gate lines and the plurality of sub-data lines intersect, wherein each second pixel unit is configured to display images according to a gate driving signal received from a corresponding gate line and a data driving signal received from a corresponding sub-data line; and
a switch circuit configured to control paths through which the plurality of data driving signals are transmitted to the plurality of sub-data lines.

2. The liquid crystal display device of claim 1 further comprising:
a gate driver configured to generate the plurality of gate driving signals;
a source driver configured to generate the plurality of data driving signals; and
a control circuit configured to generate the control signal.

3. The liquid crystal display device of claim 2 further comprising:
a timing controller configured to generate signals for operating the gate driver, the source driver and the control circuit.

4. The liquid crystal display device of claim 1 wherein each first pixel unit comprises:
a thin film transistor switch comprising:
a control end coupled to the corresponding gate line;
a first end coupled to the corresponding main data line; and
a second end;
a liquid crystal capacitor coupled between the second end of the thin film transistor switch and a common voltage; and
a storage capacitor coupled between the second end of the thin film transistor switch and the common voltage.

5. The liquid crystal display device of claim 1 wherein each second pixel unit comprises:
a thin film transistor switch comprising:
a control end coupled to the corresponding gate line;
a first end coupled to the corresponding sub-data line; and
a second end;
a liquid crystal capacitor coupled between the second end of the thin film transistor switch and a common voltage; and
a storage capacitor coupled between the second end of the thin film transistor switch and the common voltage.

6. The liquid crystal display device of claim 1 wherein the switch circuit comprises a plurality of thin film transistor switches each comprising:
a control end for receiving the control signal;
a first end coupled to a corresponding main data line; and
a second end coupled to a corresponding sub-data line.

7. A driving method of a liquid crystal display device which comprises:
a gate line;
a main data line disposed perpendicular to the gate line;
a sub-data line disposed perpendicular to the gate line;
a first pixel unit disposed at a location wherein the gate line and the main data line intersect; and
a second pixel unit disposed at a location wherein the gate line and the sub-data line intersect;
the driving method comprising:
providing a first data driving signal of a first polarity according to an image grayscale value of the first pixel unit;
providing a second data driving signal of a second polarity according to an image grayscale value of the second pixel unit;
simultaneously turning on the first pixel unit and the second pixel unit during a first enable period;
turning on the first pixel unit during a second enable period subsequent to the first enable period;
charging the second pixel unit and precharging the first pixel unit by outputting the second data driving signal to the main data line and the sub-data line during the first enable period;
charging the first pixel unit by outputting the first data driving signal to the main data line during the second enable period; and
adjusting a length of the first enable period and a length of the second enable period based on the first polarity and the second polarity.

8. The driving method of claim 7 further comprising:
shortening the length of the first enable period and increasing the length of the second enable period when the first polarity is opposite to the second polarity.

9. The driving method of claim 7 further comprising:
increasing the length of the first enable period and shortening the length of the second enable period when the first polarity is the same as the second polarity.

10. A driving method of driving a liquid crystal display device which comprises:
a first gate line, a second gate line and a third gate line;
a main data line disposed perpendicular to the first gate line, the second gate line and the third gate line;
a sub-data line disposed perpendicular to the first gate line, the second gate line and the third gate line;
a first pixel unit disposed at a location wherein the first gate line and the main data line intersect;
a second pixel unit disposed at a location wherein the first gate line and the sub-data line intersect;
a third pixel unit disposed at a location wherein the second gate line and the main data line intersect;
a fourth pixel unit disposed at a location wherein the second gate line and the sub-data line intersect;
a fifth pixel unit disposed at a location wherein the third gate line and the main data line intersect; and
a sixth pixel unit disposed at a location wherein the third gate line and the sub-data line intersect;
the driving method comprising:
providing a first data driving signal according to an image grayscale value of the first pixel unit, a second data driving signal according to an image grayscale value of the second pixel unit, a third data driving signal according to an image grayscale value of the third pixel unit, a fourth data driving signal according to an image grayscale value of the fourth pixel unit, a fifth data driving signal according to an image grayscale value of the fifth pixel unit, and a sixth data driving signal according to an image grayscale value of the sixth pixel unit;
simultaneously turning on the first pixel unit, the second pixel unit, the fifth pixel unit and the sixth pixel unit during a first enable period;
simultaneously turning on the first pixel unit and the second pixel unit during a second enable period subsequent to the first enable period;
charging the second pixel unit and precharging the first pixel unit, the fifth pixel unit and the sixth pixel unit by outputting the second data driving signal to the main data line and the sub-data line during the first enable period; and
charging the first pixel unit by outputting the first data driving signal to the main data line during the second enable period.

11. The driving method of claim 10 further comprising:
simultaneously turning on the third pixel unit and the fourth pixel unit during a third enable period subsequent to the second enable period;
simultaneously turning on the third pixel unit and the fourth pixel unit during a fourth enable period subsequent to the third enable period;
charging the fourth pixel unit and precharging the third pixel unit by outputting the fourth data driving signal to the main data line and the sub-data line during the third enable period; and
charging the third pixel unit by outputting the third data driving signal to the main data line during the fourth enable period.

12. The driving method of claim 11 further comprising:
simultaneously turning on the fifth pixel unit and the sixth pixel unit during a fifth enable period subsequent to the fourth enable period;
simultaneously turning on the fifth pixel unit and the sixth pixel unit during a sixth enable period subsequent to the fifth enable period;
charging the sixth pixel unit and precharging the fifth pixel unit by outputting the sixth data driving signal to the main data line and the sub-data line during the fifth enable period; and
charging the fifth pixel unit by outputting the fifth data driving signal to the main data line during the sixth enable period.
